(19) United States
(12) Patent Application Publication
(10) Pub. No.: US 2012/0199235 A1
(43) Pub. Date: Aug. 9, 2012

(54) DIELECTRIC STRUCTURE THAT WITHSTANDS COMPRESSION

(76) Inventors: Patrick Rybski, Yerres (FR); Bruno Truong, Lyon (FR); Michael Veaux, L'Horme (FR); Pascal Clouet, Draveil (FR)

(21) Appl. No.: 13/347,101

(22) Filed: Jan. 10, 2012

(30) Foreign Application Priority Data
Feb. 3, 2011 (FR) 1150884

(51) Int. Cl. F16L 55/00

(52) U.S. Cl. 138/108

(57) ABSTRACT

A dielectric structure (10) for an electric wire or cable, presenting an inner hollow cylindrical body (2) and an outer hollow cylindrical body (3), said bodies (2, 3) being coaxial and being connected together by a plurality of spacers (4a, 4b, 4c, 14). The main characteristic of a dielectric structure is that each spacer (14) is constituted by a first curved wall (15) and by a second curved wail (16) that is curved in the opposite direction relative to a radial plane interconnecting the two bodies (2, 3), the walls (15, 16) having at least one intersection zone (17), two successive spacers (14) being in contact with each other.

### RELATED APPLICATION

This application claims the benefit of priority from French Patent Application No. 11 50884, filed on Feb. 3, 2011, the entirety of which is incorporated by reference.

### BACKGROUND

1. Field Of The Invention

The invention relates to a dielectric structure for an electric wire or cable. Electric cables or wires are generally surrounded by a dielectric structure that serves to isolate them from any external elements. In order to preserve said electric cables or wires from any external and accidental mechanical stress that might lead to them being damaged by compression or flattening, such dielectric structures are dimensioned so as to present good mechanical strength. Thus, such dielectric structures absorb, in part or in full, the forces that arise during such unwanted stresses, by deforming to a greater or lesser extent.

2. Description of Related Art

Existing dielectric structures the present acceptable compression strength are constituted by structures of the “daisy ” type. With reference to FIG. 1a, such structures 1 present an inner hollow cylindrical body 2 and an outer hollow cylindrical body 3, said bodies 2 and 3 being coaxial and being connected together by radial walls 4a that are regularly spaced apart in the annular space between said hollow bodies 2 and 3. These walls are plane, defining a plurality of compartments 5. As shown in FIG. 1d, when subjected to an external stress of the compression type and above a certain threshold, these structures tend to deform strongly, only just maintaining the integrity of the inner body 2, and thus the integrity of the electric wire or cable housed inside said body 2. Apart from the fact of providing a level of strength that is only just satisfactory, without any safety margin, such “daisy” structures have the additional drawback of repeatedly presenting fabrication defects that are inherent to the extrusion method by which they are made. As shown in FIGS. 1b and 1c, the walls 4c need not be exactly radial, or said walls 4b may present material concentration gradients, with these two fabrication inaccuracies possibly preventing the looked-for mechanical strength being obtained, by accelerating the process whereby significant deformation appears. Other dielectric structures may reveal advantageous mechanical strength properties when subjected to compression type stress. These are foam dielectric structures. Unfortunately, the use of Freon as a foaming gas is no longer authorized, so such foaming structures cannot constitute satisfactory solutions to the problem posed.

### OBJECTS AND SUMMARY

Dielectric structures of the invention present a special shape giving them excellent mechanical strength, in particular against, flattening, as might occur, for example, as a result of compression type external stress. Furthermore, the structures can be fabricated easily and quickly, and any defects that might arise during their fabrication are unlikely to undermine the mechanical strength of said structures, with this being because of their special shape, which is capable of accommodating a certain amount of inaccuracy in fabrication.

The invention provides a dielectric structure for an electric wire or cable, the structure presenting an inner hollow cylindrical body and an outer hollow cylindrical body, said bodies being coaxial and being connected together by a plurality of spacers. The main characteristic of a structure of the invention is that each spacer is constituted by a first curved wall and by a second curved. wall that is curved in the opposite direction relative to a radial plane interconnecting the two bodies, said walls having at least one intersection zone, and two successive spacers being in contact with each other. The intended purpose of this special shape for the spacers occupying the intermediate space situated between the two hollow bodies is to be able to cancel the effect of forces transmitted through the structure during external compression in such a manner as to give rise to only minimal deformation of said structure, or indeed as to preserve its initial shape. The particular shape of each spacer, associated with the way the spacers are arranged relative to one another, provides a continuous series of walls that are in geometrically opposite positions in pairs, thereby canceling any forces transmitted through the structure during compression. An impact that initially has a radial component is transmitted along the walls of each spacer in a direction that is substantially radial until it reaches The intersection zone of the walls in each spacer. At each of these intersection zones, the impact then possesses two tangential components that are opposite, canceling mutually, thereby preventing said impact from progressing towards the inner hollow body. In a preferred embodiment of a dielectric structure of the invention, the structure has twenty-one identical spacers.

In another preferred embodiment of a structure of the invention, the two walls of a given spacer possess a single intersection zone serving to strengthen their central portions. In this way, each spacer is made up of two curved walls, the section of said spacer then being substantially X-shaped. Nevertheless, the fact that the intersection zone of the two walls corresponds to their central portions being put into contact does not mean that the contact takes place rigorously and accurately in their geometrical centers. The central portion of each wall is considered as extending in a radial direction of the structure, and the intersection zone may be provided in a non-centered sub-portion of the central portion, being offset along a radial axis. In this way, depending on the configurations encountered, the intersection zone may be located either closer to the inner body, or else closer to the outer body, or indeed equidistant between said bodies.

Advantageously, two successive spacers are in contact with each other, the first spacer possessing a wall that is in contact with a wall of the second spacer, said contact taking place at both ends of each of the walls. This configuration may be summarized as putting two objects into contact, each having an identical X-shaped section, this putting into contact having a continuous effect around the intermediate space between the two hollow bodies. The fact that all of the spacers touch one another in pairs from spacer to spacer constitutes the version of a dialectic structure of the invention chat is most effective at withstanding compression, since all of the spacers cooperate with one another for the purpose of canceling the general component of the transmitted forces. It should be specified that the concept of the “ends” of the walls should be considered relative to a radial axis of the structure.

Preferably, the space left between two successive spacers is lozenge-shaped, with its two vertices that are interconnected by an axis tangential to the structure being rounded. To be more precise, each spacer has an X-shaped section, and putting into contact two spacers that are situated at the same height serves, to reveal an “inter-spacer” gap that is lozenge-shaped. The two rounded vertices come from the curved shape of the walls of the spacers. The fact of eliminating two sharp vertices from the lozenge serves to eliminate two rupture zones that might lead to the structure being flattened when subjected to compression.

Advantageously, each lozenge is elongate in a radial direction of the structure.

In a preferred embodiment of a dielectric structure of the invention, the ratio of the width of the lozenge over its length lies in the range 0.3 to 0.7. The length of the lozenge is its dimension taken along a radial axis of the structure, and its width is its dimension taken along a tangential axis of said structure.

In another preferred embodiment of a dielectric structure of the invention, the two walls of a given spacer possess two intersection zones, serving to strengthen their ends.

Preferably, the section of each spacer leaves a central void that is lozenge-shaped.

Advantageously, the two vertices of the lozenge-shape that are interconnected by an axis tangential to the structure are rounded. For this configuration, the central void is substantially oblong in shape, being wider in its central portion. Ensuring that the vertices are rounded means that the vertices are no longer sharp, and thus do not present any edges that might constitute a line of breakage during compression.

Advantageously, the dielectric structure is made as a single piece by extrusion.

Dielectric structures of the invention for electric cables or wires present the advantage of possessing mechanical strength properties of withstanding compression that are greatly increased compared with already-existing structures, merely by a simple change of shape, they do not require any complex fabrication techniques, and they do not require any reinforcing parts to be added. Furthermore, this modification enables the general outlines of the structure to be preserved, thus enabling is to replace already-existing structures, without requiring any new arrangements or assembly readjustments.

### BRIEF DESCRIPTION OF THE DRAWINGS

There follows a detailed description of a preferred embodiment of a dielectric structure of the invention, given with reference to FIGS. 1 to 3.

FIG. 1a, described above, is an axial cross-section view of a first embodiment of a prior art dielectric structure.

FIG. 1b, described above, is an axial cross-section view of a second embodiment of a prior art dielectric structure.

FIG. 1c, described above, is an axial cross-section view of a third embodiment of a prior art dielectric structure.

FIG. 1d, described above, is an axial cross-section view of one of the three prior art embodiments of a dielectric structure, after being subjected to external compression.

FIG. 2a is an axial cross-section view of a preferred embodiment of a dielectric structure of the invention.

FIG. 2b is a perspective view of the FIG. 2a structure.

FIG. 3 is a comparative graph serving to determine the levels of compression from which a dielectric structure of the prior art and a dielectric structure of the invention become deformed.

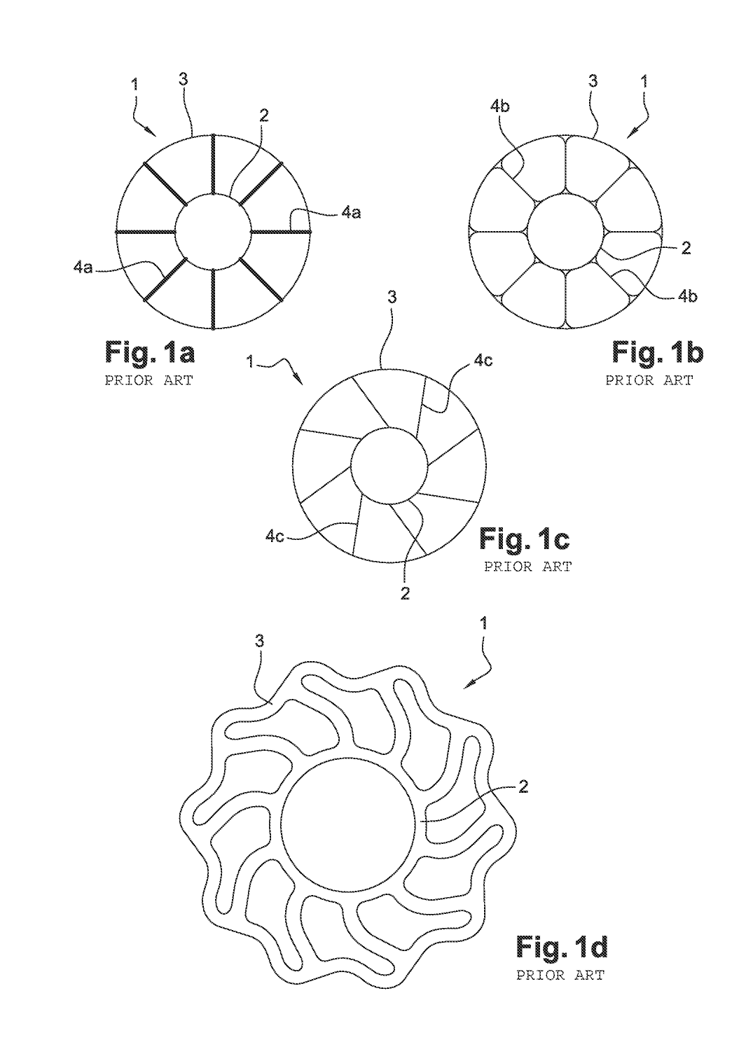

### DETAILED DESCRIPTION

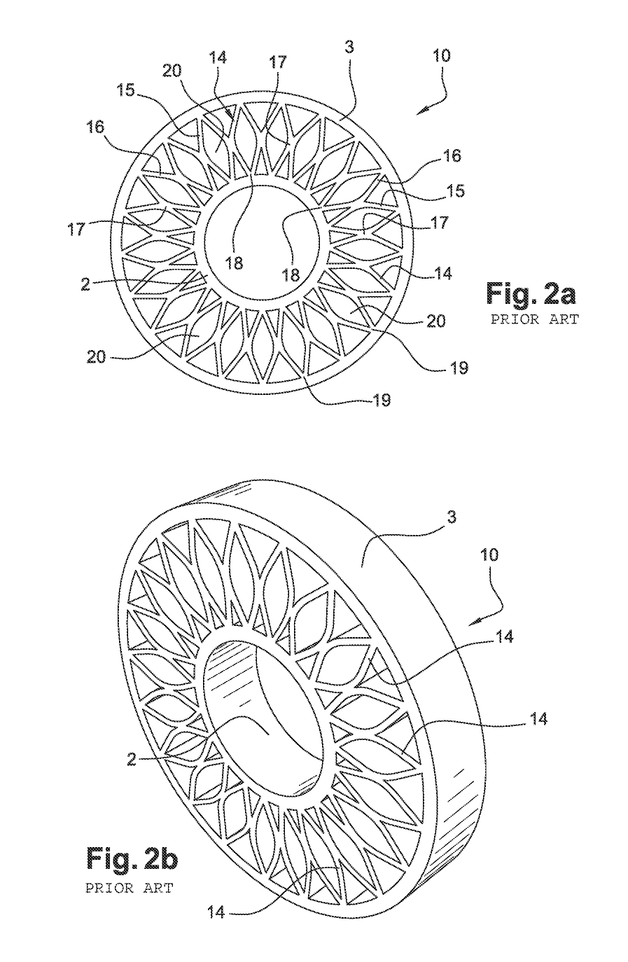

With reference to FIG. 2a, a dielectric structure 10 of the invention presents an inner hollow cylindrical body 2 and an outer hollow cylindrical body 3 that are connected together by a plurality of identical spacers 14. Each spacer 14 is constituted by a. first curved. wall 15 and by a second curved wall 16 that is curved in the opposite direction relative to a radial plane interconnecting the two bodies 2 and 3, and separating said walls 15 and 16, said walls 15 and 16 being secured to each other substantially via their central portions. This zone 17 of contact between the two walls 15 and 16 of a spacer 14 need not be accurately central, and may vary around a central position with a certain amount of tolerance. For this configuration, the essential point is than the section of each spacer 14 in a cross-section relative to a longitudinal, axis of revolution of the dialectic structure 10 of the invention is generally X-shaped. Each wall 15, 16 of a spacer 14 presents a first end 18 in contact with the inner hollow cylindrical body 2, and a second end 19 in contact with the outer hollow cylindrical body 3. The spacers 14 are arranged relative to one another around the annular space left vacant between the two hollow bodies 2 and 3 of the structure 10, in such a manner that two successive spacers 14 are in contact with each other. In other words, a wall 15 of a first spacer 14 and a wall 16 of a contiguous second spacer 14 make contact with each other at both of their ends 18 and 19, with this notion of an “end” being considered relative to a radial axis of the structure 10. Thus, a wall 15 of a first spacer 14 and a wall 16 of a second spacer 14 in contact therewith together define an opening 20 that is elongate in a radial direction of the structure 10, with the central portion thereof, situated halfway between the two cylindrical bodies 2 and 3, being enlarged with a rounded outline. The two ends of this opening 20, each situated in the vicinity of a respective one of said bodies 2 and 3, are defined by the two walls 15 and 16 together forming an acute angle. Roughly speaking, each opening 20 between two successive spacers 14 is in the form of an elongate lozenge, with its two vertices that are interconnected by an axis tangential to the structure 10 being rounded. One dielectric structure 10 of the invention possesses twenty-one spacers 14 and is made as a single piece by extrusion. Above, for the purposes of describing the particular shape of a dielectric structure 10 of the invention, the structure 10 is subdivided into a plurality of individual and identical spacers 14, however in reality and in a preferred embodiment of a dielectric structure 10 of the invention, the structure 10 is constituted as a single block made in a single extrusion operation.

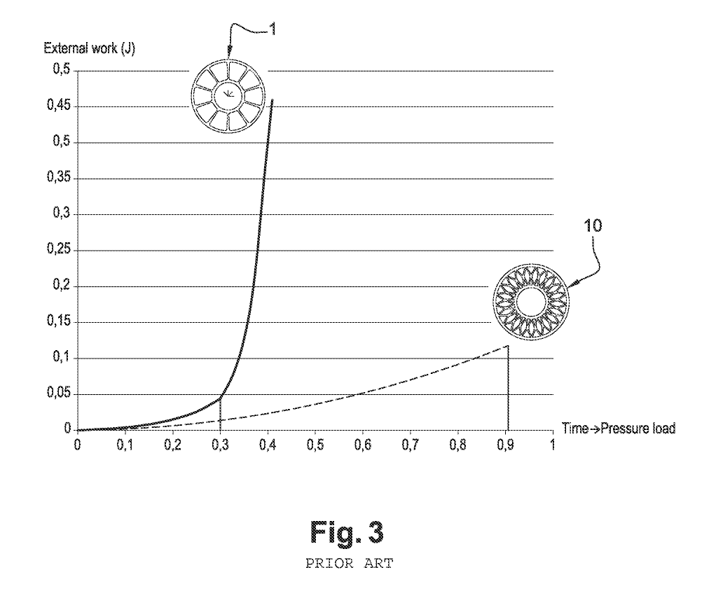

With reference to FIG. 3, the magnitude plotted up the ordinate of the graph is proportional to the overall deformation of the structure 1 or 10, while the abscissa corresponds to the pressure applied to said structure 1 or 10. It can be seen that the pressure needed. for deforming the dielectric structure 10 of the invention, plotted as a dashed-line curve, is much greater than the pressure needed for deforming the prior art dielectric structure 1, plotted using a continuous-line curve. It can easily be seen that the “daisy” structure 1 begins to deform at a pressure of 0.3, whereas the dielectric structure 10 of the invention only begins to deform beyond a pressure of 0.9, which is three times greater. This tends to show that a dielectric structure 10 of the invention is at least three times stronger in compression than a dielectric structure 1 of the prior art “daisy” type.

1. A dielectric structure for an electric wire or cable, comprising:
an inner hollow cylindrical body; and
an outer hollow cylindrical body, said bodies being coaxial and being connected together by a plurality of spacers, wherein each spacer is constituted by a first curved wall and by a second curved wall that is curved in the opposite direction relative to a radial plane interconnecting the two bodies, said walls having at least one intersection zone, and in that two successive spacers are in contact with each other.

2. A structure according to claim 1, wherein the two walls of a given spacer possess a single intersection zone serving to strengthen their central portions.

3. A structure according to claim 1, wherein two successive spacers are in contact with each other, the first spacer possessing a wall that is in contact with a wall of the second spacer, said contact taking place at both ends of each of the walls.

4. A structure according to claim 3, wherein the space left between. two successive spacers is lozenge-shaped, with its two vertices that are interconnected by an axis tangential to the structure being rounded.

5. A structure according to claim 4, wherein each lozenge is elongate in a radial direction of the structure.

6. A structure according to claim 5, wherein the ratio of the width of the lozenge over its length lies in the range 0.3 to 0.7.

7. A structure according to claim 1, wherein the two walls of a given spacer possess two intersection zones, serving to strengthen their ends.

8. A structure according to claim 7, wherein the section of each spacer leaves a central void that is lozenge-shaped.

9. A structure according to claim 8, wherein the two vertices of the lozenge-shape that are interconnected by an axis tangential to the structure are rounded.

10. A structure according to claim 1, wherein said structure is made as a single piece by extrusion.
